(19) United States
(12) Patent Application Publication
(10) Pub. No.: US 2026/0320042 A1
(43) Pub. Date: Oct. 15, 2026

(54) ARTIFICIAL INTELLIGENCE SERVICE APPARATUS AND ARTIFICIAL INTELLIGENCE SERVICE METHOD

(71) Applicant: GWANGJU INSTITUTE OF SCIENCE AND TECHNOLOGY, Gwangju (KR)

(72) Inventors: Wahidur S M Rahman, Gwangju (KR); Heung-No Lee, Gwangju (KR); Sumin Kim, Gwangju (KR); Haeung Choi, Gwangju (KR)

(21) Appl. No.: 19/537,166

(22) Filed: Feb. 11, 2026

(30) Foreign Application Priority Data
Apr. 9, 2025 (KR) 10-2025-0046007

(51) Int. Cl. G06F 16/2452; G06F 16/2457; G06N 3/042

(52) U.S. Cl. CPC G06F 16/24522; G06F 16/24578; G06N 3/042

(57) ABSTRACT

Provided is an artificial intelligence service method may include performing, from a vector database, a first relevance search based on a criterion having high first relevance to a vector-representation query to retrieve N related data chunks; re-ranking the N related data chunks based on a criterion having high second relevance to the vector-representation query; and selecting, from among the N related data chunks, M related data having high second relevance.

### BACKGROUND

### 1. Field of the Invention

The present disclosure relates to an artificial intelligence service apparatus and an artificial intelligence service method.

the present disclosure relates to an artificial intelligence service based on retrieval-augmented generation (RAG: Retrieval-Augmented Generation).

The present disclosure further relates to an artificial intelligence service apparatus and an artificial intelligence service method suitable for legal information services.

### 2. Description of the Related Art

An artificial intelligence service is applied to a legal information service. Accordingly, advantages may be obtained in that rapid legal information search is possible, complex tasks are simplified, and efficiency of tasks is improved. Here, as an example of the artificial intelligence service, generative AT may be representative. For example, as a large language model LLM Large Language Model (hereinafter, may be referred to as a model or a language model) is introduced, an artificial intelligence service for a legal information service is being further expected.

Among problems of the artificial intelligence service, the Retrieval-Augmented Generation RAG Retrieval-Augmented Generation has been proposed as a method capable of minimizing a hallucination problem. The Retrieval-Augmented Generation has, as one feature, combining information search with the model LLM. The Retrieval-Augmented Generation can provide more accurate and richer information by causing the model to answer by referring to searched information.

Nevertheless, even when RAG is employed, there remain limitations in obtaining responses with sufficiently high reliability. For example, Korean Registered Patent No. 10-2701184 discloses a technique of separating storage resources in RAG. However, due to the vastness and complexity of legal information, it remains difficult to obtain highly reliable answers to legal queries.

### SUMMARY

The present invention is proposed based on the above-described background, and an object of the present invention is to provide an artificial intelligence service apparatus and an artificial intelligence service method providing a highly reliable answer.

An object of the present invention is to provide an artificial intelligence service apparatus and an artificial intelligence service method suitable information service.

An artificial intelligence service method of the present disclosure discloses a process of obtaining a response to a user question based on Retrieval-Augmented Generation.

The method may repeat obtaining a first response to a user first question, improving the first question into a second question as a response to that the first response to the user first question fails to pass verification, and obtaining a second response to the second question.

In the method, a process of obtaining a current response to a user current question may include: converting the current question into a vector-representation query; from a vector DB, performing a first relevance search based on a criterion having high first relevance to the vector-representation query, and searching N related data chunks; re-ranking the N related data chunks based on a criterion having high second relevance to the vector-representation query; and selecting, from among the N related data chunks, M related data having high second relevance.

In the method, the method may include: generating the current response by using the M related data and the vector-representation query; verifying the current response; and, when the current response passes the verification, outputting the current response as a final response, and when the current response fails to pass the verification, suppressing transmission or display of the current response and providing the current question as another improved question.

In the method, the first relevance search and the second relevance search may evaluate relevance by different methods.

In the method, the first relevance search may use a hybrid search combining keyword search and semantic search.

In the method, the second relevance search may use cosine similarity.

In the method, M may be smaller than N.

Verifying the response may include at least one of verifying context relevancy, verifying answer relevancy, and verifying groundness.

When A is the response, Q is the question, C is the related data, and N is the number of total questions, as a response to including verifying context relevancy, verifying context relevancy may include averaging cosine similarity between the question and the related data.

When A is the response, Q is the question, C is the related data, and N is the number of total questions, as a response to including verifying answer relevancy, verifying answer relevancy may include averaging cosine similarity between the question and the answer.

When A is the response, Q is the question, C is the related data, and N is the number of total questions, as a response to including verifying groundness, verifying groundness may include averaging cosine similarity between the answer and the related data.

When verifying context relevancy, verifying answer relevancy, and verifying groundness are included in a predetermined threshold, it may be determined that a current response passes verification. The predetermined threshold for passing verification is distinct from a lower-bound threshold indicating insufficient context availability, and the thresholds serve different decision purposes.

The present disclosure can improve operation of a question-and-answer computer system by: first, reducing an amount of context processed by a response generation LLM through a two-stage relevance selection N-M; and second, preventing display/transmission of a response when a mechanically verifiable relevancy/groundness score does not satisfy a threshold.

Verifying answer relevancy and verifying groundness may be applied more strictly than verifying context relevancy.

An artificial intelligence service apparatus of the present disclosure may include at least one memory storing data and at least one instruction for processing the data, and at least one processor executing the instruction, in order to obtain a response to a user question based on Retrieval-Augmented Generation.

In the apparatus, the at least one processor, in order to obtain a response to a user question, may include: converting the user question into a vector-representation query; from the at least one memory, performing a first relevance search based on a criterion having high first relevance to the vector-representation query and searching N related data chunks; re-ranking the N related data chunks based on a criterion having high second relevance to the vector-representation query; and selecting, from among the N related data chunks, M related data having high second relevance.

In the apparatus, the apparatus may include: generating the response by using the M related data and the vector-representation query; verifying the response; and, when the response passes the verification, outputting the response as a final response, and when the response fails to pass the verification, improving the question into another question and providing the improved question.

The apparatus is characterized by satisfying at least one of: the first relevance search and the second relevance search evaluate relevance by different methods; the first relevance search uses a hybrid search combining keyword search and semantic search; the second relevance search uses cosine similarity; and M is smaller than N.

The artificial intelligence service of the present invention can provide a highly reliable answer in response to a user query.

The artificial intelligence service of the present invention can provide a highly reliable answer for a legal query.

### BRIEF DESCRIPTION OF THE DRAWINGS

FIG. 1 is a schematic configuration diagram of an artificial intelligence service apparatus of the present disclosure.

FIGS. 2 and 3 are drawings illustrating a detailed configuration of the artificial intelligence service apparatus of the present disclosure and individual operations of the configuration.

FIG. 4 is a drawing illustrating data ingestion.

FIGS. 5 and 6 are drawings illustrating query/response.

FIG. 7 is a drawing illustrating in detail an artificial intelligence service method performed by the reduction module.

FIG. 8 is a drawing illustrating in detail an artificial intelligence service method performed by the verification module.

### DETAILED DESCRIPTION OF THE EMBODIMENTS

Hereinafter, specific embodiments of the present disclosure will be described in detail with reference to the drawings. However, the present disclosure is not limited to the following embodiments of the spirit of the present disclosure, and a person having ordinary skill in the art who understands the spirit of the present disclosure will be able to easily propose other embodiments included within the scope of the same spirit by addition, modification, deletion, and addition of components, and this is also included within the scope of the spirit of the present disclosure.

In describing the drawings, regardless of reference numerals of the drawings, identical or similar components are given identical or similar reference numerals, and overlapping description thereof may be omitted. In the following description, suffixes “module”, “unit”, and “part” for components are given or used interchangeably only in consideration of convenience of specification drafting, and do not have meanings or roles distinguished from each other by themselves. The “module”, “unit”, and “part” may operate by at least one processor. The “module”, “unit”, and “part” may operate by at least one arithmetic device, at least one input device, at least one display device, and at least one memory.

In describing embodiments disclosed in this specification, when it is determined that detailed description of related known technology may obscure the gist of the embodiments disclosed in this specification, the detailed description will be omitted. The accompanying drawings are only for allowing the embodiments disclosed in this specification to be easily understood, and the technical spirit disclosed in this specification is not limited by the accompanying drawings, and it should be understood that the drawings include all changes, equivalents, and substitutes included in the spirit and technical scope of the present disclosure.

Terms including ordinal numbers such as first and second may be used to describe various components, but the components are not limited by the terms. The terms are used only for the purpose of distinguishing one component from another component. When a component is referred to as being “connected” or “coupled” to another component, it may be directly connected or coupled to the other component, but it should be understood that another component may exist in between. On the other hand, when a component is referred to as being “directly connected” or “directly coupled” to another component, it should be understood that no other component exists in between.

A singular expression may include a plural expression unless clearly different in context. In the present application, terms such as “include” or “have” are intended to specify that features, numbers, steps, operations, components, parts, or combinations thereof described in the specification exist, and should be understood as not excluding in advance the existence or addition possibility of one or more other features, numbers, steps, operations, components, parts, or combinations thereof.

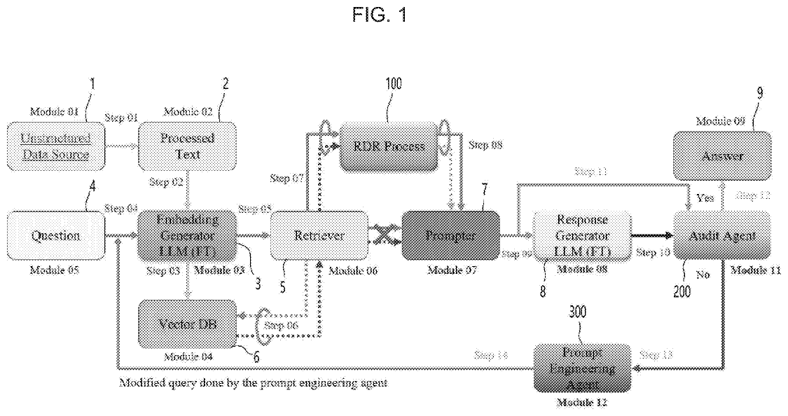

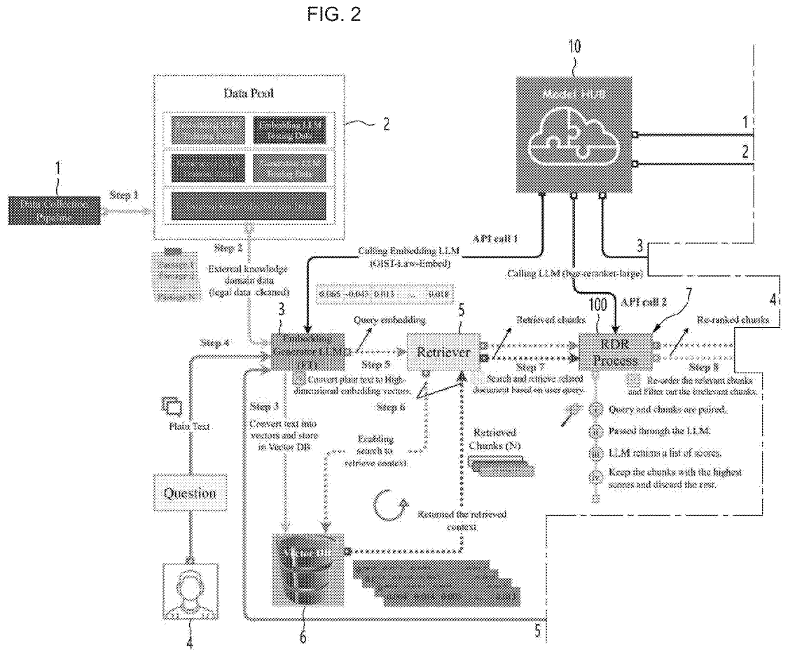

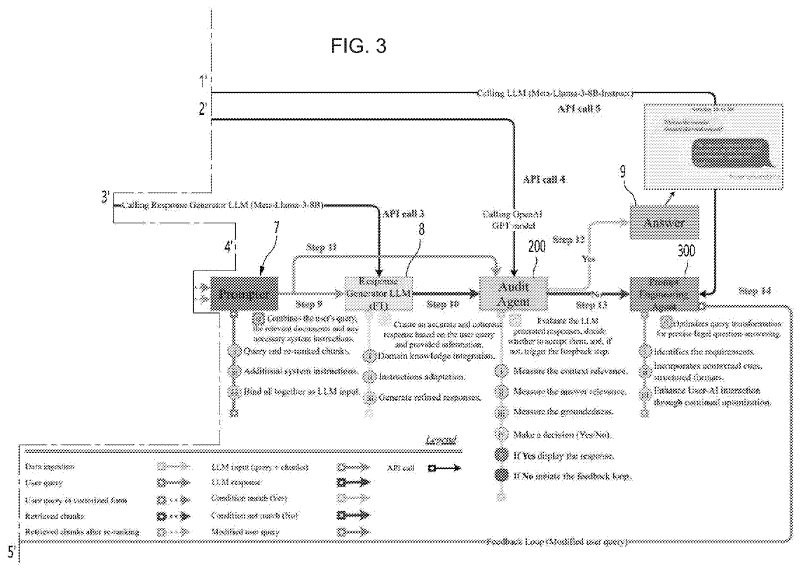

FIG. 1 is a schematic configuration diagram of the artificial intelligence service apparatus of the present disclosure. FIGS. 2 and 3 are drawings illustrating a detailed configuration of the artificial intelligence service apparatus of the present disclosure and individual operations of the configuration. FIGS. 2 and 3 are connected drawings, and a right end of FIG. 2 and a left end of FIG. 3 may be connected to each other. Reference is made to FIGS. 1 to 3.

An input module 1 may input unstructured data. The unstructured data may be mainly text-based and may be information that does not follow an existing row-column database structure. The unstructured data may include other data types such as dates, numbers, and facts. External data may be input through the input module 1.

An input data processing module 2 may process data input through the input module 1. Text processed by the input data processing module 2 may be arranged and converted into a consistent format. As a converted result, the text may appear as text suitable for analysis and machine learning tasks. The input data processing module 2 may include at least one language model. In the input data processing module 2, at least one operation among removal of irrelevant information, correction of errors, and standardization of a text structure may be performed. The converted information may include legal information.

An embedding generation module Embedding Generator 3 may convert text into high-dimensional vector representations in a shared vector space. The embedding generation module 3 may be an LLM. The text may include a question query and converted text. Here, the converted text may be text processed by the input data processing module 2. Here, the question may be a question input through a question module 4.

A vector DB 6 may store vector information generated by the embedding generation module Embedding Generator 3. The vector DB 6 may efficiently store the vector information and may quickly search related information. The vector DB 6 is optimized for related work of vector information. Accordingly, fast query processing and scalability can be obtained.

The question module 4 may input a question. The question may mean a query submitted by a user to the system. The question may include specific details or context required to search related information and generate a response. As an example of the question, “When was the U.S. Constitution signed, and who was the convention president?” may be given. The question may be embedded by the embedding generation module 3 and converted into a vector representation.

A retrieval module Retriever 5 may search for a related document or related information for responding to the user question. The retrieval module 5 may search the vector DB 6 by using the question and search information useful for a response. Here, the question may be in a form of vector information. In search of the retrieval module Retriever 5, a hybrid search technology may be used. The hybrid search may combine keyword search and semantic search. The keyword search may be an information retrieval algorithm that scores and ranks related documents for a specific question. The keyword search may use BM25 Best Match 25. The semantic search aims to improve accuracy and relevance of search results by understanding context and meaning behind the question.

A question input to the retrieval module 5 may be “What are the key provisions of contract law?” The retrieval module 5 may search, from the vector DB 6, documents related to contract law that may help find an answer to the question. For example, documents discussing key provisions, definitions, and conditions of contract law may be found. Information searched from the vector DB 6 may be transmitted to the retrieval module 5 as a plurality of data chunks. Here, the number of the plurality of chunks may be N.

The plurality of chunks may be transmitted to a reduction module Retrieved Document Reduction 100. The question query may be transmitted to the reduction module 100. The reduction module 100 may include a language model. The reduction module 100 may re-rank the N data chunks. At this time, the reduction module 100 may compare cosine similarity of relevance between the question and the N data chunks. The reduction module 100 may rank data chunks having higher relevance to the query at higher priority based on relevance to the query. The reduction module 100 may select M data chunks having higher relevance from the ranked data chunks. Here, M may be smaller than N. By the reduction module 100, data having higher relevance may be filtered and reliability of relevance may be increased. The numbers M and N may be different. For example, M and N may be natural numbers. N may be 15, and M may be 5.

The reduction module 100 evaluated relevance between the question and the N data chunks by using cosine similarity. In contrast, the retrieval module 5 used the hybrid search when searching relevance of information of the vector DB 6 by using the question. A first relevance search performed in the retrieval module 5 used the hybrid search. A second relevance search performed in the reduction module 100 used cosine similarity. By selecting N data chunks as a result of the first relevance search and selecting M data chunks among N as a result of the second relevance search, data having high relevance may be transmitted to a prompter module 7. The first relevance search and the second relevance search may search relevance of data by using different relevance. Accordingly, the first and second relevance searches may show results having different degrees of relevance. As another example, the first relevance search may apply the hybrid search, and the second relevance search may use another method such as using a relevance score calculated by a cross encoder or a language-model-based re-ranker.

The prompter module Prompter 7 may combine the user question, data reduced by the reduction module 100, and necessary system instructions. Information combined in the prompter module 7 may be input to a response generation module Response Generator LLM 8.

The response generation module 8 may generate an accurate and consistent response by using context provided by the retriever Retriever and the prompter Prompter together with a user query question. The response generation module 8 may include a language model.

A verification module Audit agent 200 may verify a response generated by the response generation module 8. The verification module 200 may verify by comparing the user query and the response. The verification module 200 may evaluate at least one of matching with an original query of the user answer relevancy, relevance of used context context relevancy, and factual accuracy of an assertion groundness.

As a verification result of the verification module 200, when verification is passed, the response may be transmitted to an output module 9 and may be output. As a verification result of the verification module 200, when verification is not passed, the question query may be transmitted to a query improvement module 300. The query improvement module 300 may improve the user query. The query improvement module 300 may include a language model. For example, an agent of Meta-Llama-3-8B-Instruct may be used as the query improvement module 300. A user question improved in the query improvement module 300 may be input again to the embedding generation module 3. The question input at this time is differentiated from the first question initially input by the user, and may be referred to as a second question. Improvement of the question may be based on an item in which the verification result does not satisfy a threshold. For example, the question may be reconstructed by adding or deleting at least one of a core keyword, a scope, and a condition of the question. As a specific example, when the first question is “According to the 25th Amendment, what is the protocol when the President of the United States is incapacitated and unable to fulfill his duties, particularly in the context of the 14th Amendment's provisions on citizenship and representation?”, the second question may be changed to “How does the 25th Amendment address the issue of presidential incapacity, and what steps are taken to ensure a smooth transition of power?” The second question may be rewritten to reduce ambiguity while maintaining a semantically same scope as the first question.

By the second question input to the embedding generation module 3, operation of the artificial intelligence service apparatus of the present disclosure may be performed again. A second response by operation of the artificial intelligence service apparatus by the second question may pass the verification module 200. In this case, the second response may be output to the output module 9. When the second response fails to pass the verification module 200, a third query may be provided by the query improvement module 300. The above-described operation may be repeated until the response is satisfied.

Reference is made to FIGS. 2 and 3. For operation of the artificial intelligence service apparatus of the present disclosure, a model hub 10 may be provided. The model hub 10 may store and train a model for operation of the artificial intelligence service apparatus. At least one among the embedding generation module 3, the reduction module Retrieved Document Reduction 100, the response generation module 8, the verification module Audit agent 200, and the query improvement module 300 may be connected to the model hub 10 via an API. The embedding generation module 3, the reduction module Retrieved Document Reduction 100, the response generation module 8, the verification module Audit agent 200, and the query improvement module 300 may each be connected to the model hub 10 via an API. The embedding generation module 3, the reduction module Retrieved Document Reduction 100, the response generation module 8, the verification module Audit agent 200, and the query improvement module 300 may operate as different models.

It can be understood that operations of each module disclosed in FIGS. 2 and 3 are included in the contents of the present disclosure. Each step of FIGS. 2 and 3 may be used for description of the artificial intelligence service method of the present disclosure. Likewise, the following description of the artificial intelligence service method may be used to describe operations of the artificial intelligence service apparatus.

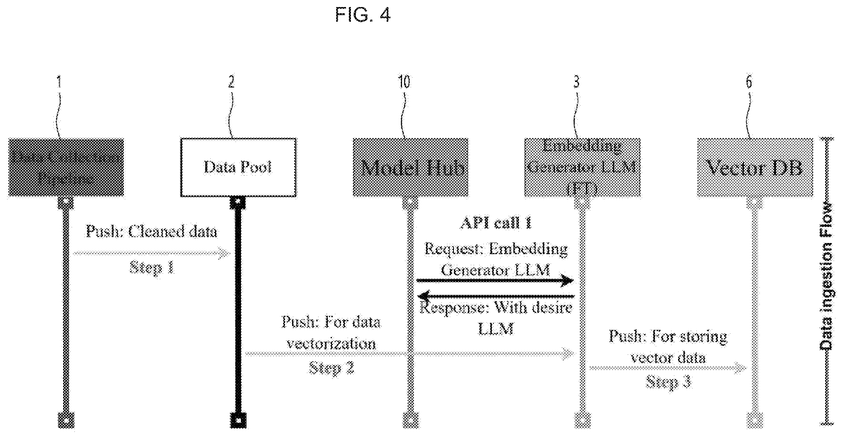

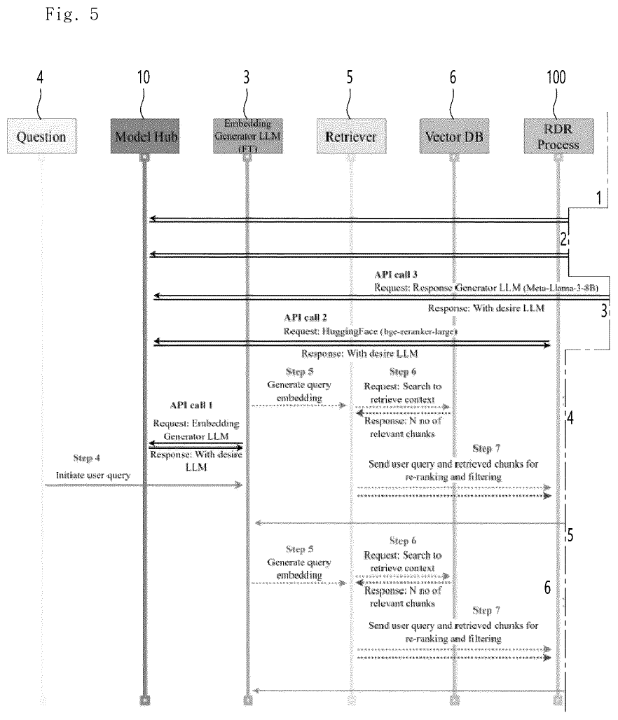

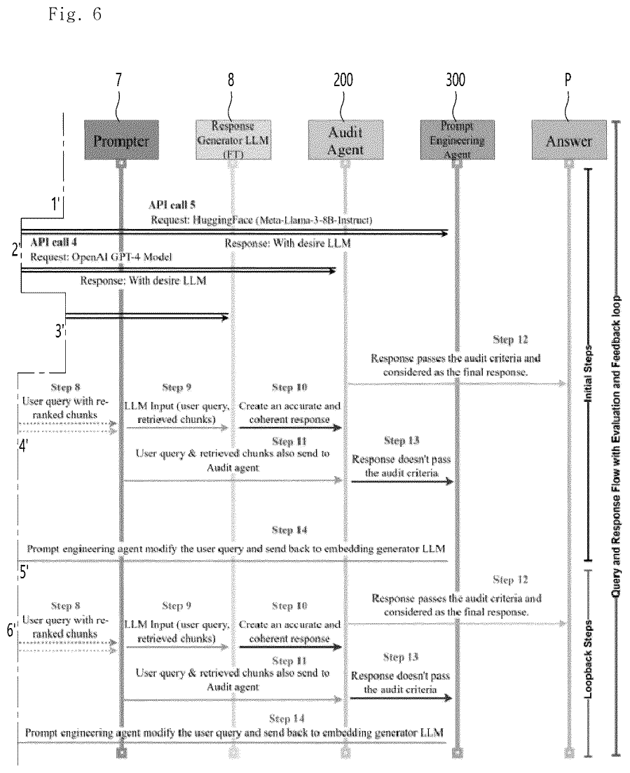

Hereinafter, the artificial intelligence service method of the present disclosure will be described. FIG. 4 is a drawing illustrating data ingestion. FIGS. 5 and 6 are drawings illustrating query/response. FIGS. 5 and 6 are connected drawings, and a right end of FIG. 5 and a left end of FIG. 6 may be connected to each other.

Reference is made to FIGS. 4 to 6. The data ingestion may include inputting unstructured data from the input module 1 in step S1, and converting, by the input data processing module 2, data input through the input module 1 and inputting the converted data to the embedding generation module Embedding Generator LLM 3 in step S2. The embedding generation module may convert text into high-dimensional vector representations in a shared vector space.

In order for the embedding generation module to construct a language model, the embedding generation module may request a first language model from the model hub 10, and the model hub 10 may perform providing the first language model to the embedding generation module by an API call API call 1.

The data ingestion may include converting, by the embedding generation module 3, text into high-dimensional vector representations and storing vectors in the vector DB 6 in step S3. The vector DB may include legal information.

The query/response may include that at least one among the reduction module Retrieved Document Reduction 100, the response generation module 8, the verification module Audit agent 200, and the query improvement module 300 requests respective language models from the model hub 10, and that the model hub 10 provides each language model, by API calls API call 2 to API call 5. The question may include that a user provides a question query. The response may include a response provided by the artificial intelligence service in response to the user question. The reduction module Retrieved Document Reduction 100 may have a second language model. The response generation module 8 may have a third language model. The verification module Audit agent 200 may have a fourth language model. The query improvement module 300 may have a fifth language model.

The query/response may include that a user asks a question in step S4. The question may be embedded in the embedding generation module 3 and converted into a vector representation in step S5. The retrieval module 5 may search the vector DB 5 by using the vector-represented question and may search information useful for a response in step S6. The retrieval module 5 may provide, for example, N related data chunks. For example, N may be 15. The retrieval module 5 may perform the first relevance search. The first relevance search may use the hybrid search technology.

The N related data chunks and the question may be transmitted to the reduction module Retrieved Document Reduction 100 in step S7. The reduction module 100 may re-rank the N data chunks. The reduction module 100 may rank data chunks having higher relevance based on relevance to the query, and may select M data chunks having higher relevance from the ranked data chunks. Here, M may be smaller than N. M may be 5. By the reduction module 100, data having higher relevance may be filtered and reliability of relevance may be increased. The reduction module 100 may perform the second relevance search. The second relevance search may use cosine similarity.

By selecting N data chunks as a result of the first relevance search and selecting M data chunks among N as a result of the second relevance search, M related data chunks having higher relevance may be transmitted to the prompter module 7.

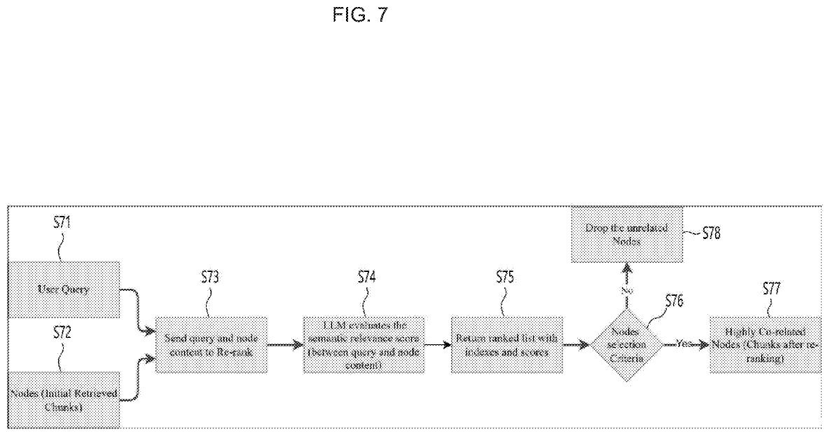

FIG. 7 illustrates, in detail, an artificial intelligence service method performed by the reduction module, precisely, a reduction process. Reference is made to FIG. 7. Transmission of the user query in step S71 and transmission of N data chunks searched by the first relevance search in step S72 may be performed. The user query and the N data chunks may be input to the reduction module in step S73. The reduction module may re-evaluate the N data chunks by the second language model in step S74. The second language model may perform the second relevance search. The second relevance search may use cosine similarity. Mathematical Expression 1 is a drawing illustrating cosine similarity.

$$cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} \qquad [ Mathematical Expression 1 ]$$

$$Here ’ s a breakdown of the formula :$$

$$cos ( θ ) is the cosine of the angle θ between the two vectors .$$

$$A \cdot B is the dot product of vectors A and B .$$

$$‖ A ‖ and ‖ B ‖ are the magnitudes ( or norms ) of vectors A and B , respectively .$$

$${\sum }_{i = 1}^{n} {A}_{i} {B}_{i} is the sum of the products of the corresponding entries of$$

$$the vectors .$$

$${\sum }_{i = 1}^{n} {A}_{i}^{2} and {\sum }_{i = 1}^{n} {B}_{i}^{2} are the sums of the squares of the components$$

$$of vectors A and B , respectively .$$

In Mathematical Expression 1, A is a question, B is searched data, Ai is an i-th entry of a question vector, and Bi is an i-th entry of a data vector.

By the second relevance search using cosine similarity, the M data chunks may be re-ranked such that higher similarity has higher priority according to a similarity score. That is, data chunks having higher similarity may be re-ranked to a higher rank in step S75. Thereafter, a selection condition may be applied to select data chunks satisfying the selection condition in step S76. The selection condition may be N data chunks in an order of high similarity score. For example, among re-ranked N data chunks, M data chunks may be selected in an order of high similarity score.

The selected M data chunks may be used in step S77. The unselected N-M data chunks may not be used in step S78.

Reference is made again to FIGS. 4 to 6. The prompter module Prompter 7 may perform combining the user question and data reduced by the reduction module 100 (M data chunks) and required system instructions, and transmitting combined information to the response generation module 8. The prompter module 7 may transmit the combined information to the prompter module Prompter 7 and the verification module Audit agent 200 in steps S9 and S11.

The response generation module 8 may perform generating a response and transmitting the response to the verification module 200 in step S10.

The verification module 200 may verify the response. The verification module 200 may verify by comparing the user query and the response. The verification module 200 may evaluate at least one of matching with the user question answer relevancy, relevance of used context context relevancy, and factual accuracy of an assertion groundness.

The verification module 200 is not limited to calculating a score using cosine similarity. In some embodiments, the verification module 200 may calculate context relevancy score CR, answer relevancy score AR, and groundness/factual accuracy score GR by a language-model-based evaluation function. For example, the language-model-based evaluation function may output CR/AR/GR scores by evaluating the response generated in view of searched context based on a language-model-based evaluation configured to output verification scores and optional explanation data.

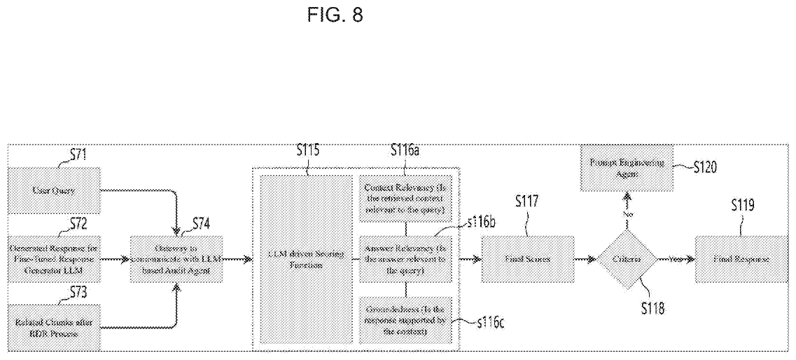

FIG. 8 illustrates, in detail, an artificial intelligence service method performed by the verification module, precisely, an audit process. Reference is made to FIG. 8. Transmission of the user question in step S111, transmission of the response in step S112, and transmission of reduced data in step S113 may be performed. The user question, the response, and the reduced data may be input to the verification module 200 in step S114.

Applying the fourth language model in step S115 and performing verification in step S116 may be performed. The verification performing step S116 may be performed as evaluating the response from at least one among the following three viewpoints. The verification performing step S116 may include at least one of verifying context relevancy (step S116a), matching with the user question answer relevancy (step S116b), and factual accuracy of an assertion groundness (step S116c).

The verification performing may be performed by obtaining cosine similarity. Specifically, verifying context relevancy step S116a evaluates relevance between context and question. The context may mean data reduced in the reduction module. The context may mean information included in the M data chunks. It is preferable that the context includes as little content unrelated to the question as possible. A size of the context is related to a size of text input to the language model, and this closely acts with cost. The cost may mean processing cost, and may mean an operational aspect and an increase in time complexity. If a length of the context is long, the language model is not efficient in extracting content related to a correct answer from the context.

$$CR ( A , C ) = ( 1 / N ) {\sum }_{i = 1}^{N} {f}_{score} ( {Q}_{i} , {C}_{i} ) \qquad Mathematical Expression 2$$

Here, CR is context relevancy, A is an answer, Q is a query, C is a context, N is the number of total queries, f is cosine similarity presented in Mathematical Expression 1, and i may mean an i-th entry.

According to Mathematical Expression 2, in order to calculate context relevancy, an average of cosine similarity between the question and the context is used. According to Mathematical Expression 2, context relevancy can be obtained.

Matching with the user question answer relevancy step S116b may evaluate relevance between the context and the response. Answer relevancy may evaluate whether a generated response is related to content of a given question.

$$A R ( A , C ) = ( 1 / N ) {\sum }_{í = 1}^{N} {f}_{score} ( {Q}_{i} , {A}_{i} ) \qquad Mathematical Expression 3$$

Mathematical Expression 3 is a mathematical expression for evaluating answer relevancy. Each symbol may be the same as in Mathematical Expression 2.

Factual accuracy of an assertion groundness step S116c may evaluate an ability of the model to distinguish a factual input and a hallucinatory input. Accordingly, reliability of the model may be measured. The indicator may check whether the generated response is based on reliable information.

$$G ( A , C ) = ( 1 / N ) {\sum }_{t = 1}^{N} {f}_{score} ( {A}_{i} , {C}_{i} ) \qquad Mathematical Expression 4$$

Mathematical Expression 4 is a mathematical expression for evaluating the factual accuracy. Each symbol may be the same as in Mathematical Expression 2.

By performing verification in step S116, cosine similarity of each of the three viewpoints may be derived as a score. By the verification, at least one cosine similarity may be calculated. The at least one cosine similarity may include three cosine similarity values in step S117.

A verification result may be obtained by evaluating the at least one cosine similarity in step S118. A verification result may be obtained by individually evaluating the at least one cosine similarity. A verification result by cosine similarity may be represented by Mathematical Expression 5.

$$Mathematical Expression 5$$

$$Decision ( CR , AR , G ) = \{ \begin{matrix}Accepted , & \begin{matrix}if C R ∈ [ 0.65 , 1 ] , \\ AR ∈ [ 0. 80 , 1 ] , GR ∈ [ 0.8 , 1 ]\end{matrix} \\ Rejected , & \begin{matrix}if C R ∉ [ 0.65 , 1 ] , \\ AR ∉ [ 0.80 , 1 ] , G R ∉ [ 0.8 , 1 ]\end{matrix}\end{matrix}$$

According to Mathematical Expression 5, a verification result may be obtained by individually determining context relevancy CR, answer relevancy AR, and factual accuracy GR.

A pass indicator of context relevancy CR may be 0.65 to 1.00. A pass indicator of answer relevancy AR may be 0.80 to 1.00. A pass indicator of factual accuracy GR may be 0.80 to 1.00. When any cosine similarity among the viewpoints fails to satisfy the pass indicator, it may be determined that verification fails.

Also, when context relevancy CR is equal to or less than a preset lower limit (e.g., CR ≤0.09) or when groundness/factual accuracy GR is equal to or less than a preset lower limit (e.g., GR ≤0.1), the system may determine that searched context is insufficient. In this case, instead of generating a response based on searched context, the system may generate a response using a general-purpose language model based on pretrained knowledge, and the output module 9 may output a warning indicating that a response may be inaccurate because provided documents do not include sufficient information. In this case, the process may move to the query improvement module 300 in step S120.

When all cosine similarity values among the viewpoints satisfy the pass indicator, it may be determined that verification is passed. In this case, the process may move to the output module 9 in step S119.

The context relevancy related to cost may have a wider pass range than the other two indicators. The hallucination problem and the response relevancy problem may be further improved.

Reference is made again to FIGS. 4 to 6. As a verification result of the verification module, when verification is passed, a current response may be transmitted to the output module 9 as a final response in step S12.

As a verification result of the verification module, when verification is not passed, the question query may be transmitted to the query improvement module 300 in step S13.

The query improvement module 300 may perform improving the user query, and the improved user question (the second question) may be input again to the embedding generation module 3 in step S14. By the second question input to the embedding generation module 3, operation of the artificial intelligence service apparatus of the present disclosure may be performed again. Thereafter, operations as already described may be performed again. The operation, the artificial intelligence service method, may repeat until the pass indicator is satisfied.

By allowing output only when a verification threshold is satisfied and repeatedly improving the query, the system can reduce hallucinatory responses and avoid unnecessary computation accompanying processing of a long context having low relevance.

According to the present disclosure, a highly reliable response can be provided. According to the present invention, it can be preferably applied to legal information search in which vast and complex data exists and accurate information search is required.

What is claimed is:

1. An artificial intelligence service method that repeats, as a process of obtaining a response to a user question based on Retrieval-Augmented Generation, obtaining a first response to a user first question, improving the first question into a second question as a response to that the first response to the user first question fails to pass verification, and obtaining a second response to the second question,
wherein a process of obtaining a current response to a user current question comprises:
converting a current question into a vector-representation query;
from a vector DB, performing a first relevance search based on a criterion having high first relevance to the vector-representation query, and searching N related data chunks;
re-ranking the N related data chunks based on a criterion having high second relevance to the vector-representation query;
selecting, from among the N related data chunks, M related data chunks having high second relevance;
generating the current response by using the M related data chunks and the vector-representation query;
verifying the current response; and
when the current response passes the verification, outputting the current response as a final response, and when the current response fails to pass the verification, providing the current question as another improved question.

2. The artificial intelligence service method of claim 1, wherein the first relevance search and the second relevance search evaluate relevance by different methods.

3. The artificial intelligence service method of claim 2, wherein the first relevance search uses a hybrid search combining keyword search and semantic search, and the second relevance search uses cosine similarity.

4. The artificial intelligence service method of claim 1, wherein M is smaller than N.

5. The artificial intelligence service method of claim 1, wherein verifying the response comprises at least one of verifying context relevancy, verifying answer relevancy, and verifying groundness.

6. The artificial intelligence service method of claim 5, wherein when A is the response, Q is the question, C is the related data, and N is the number of total questions,
as a response to including verifying context relevancy, verifying context relevancy is averaging cosine similarity between the question and the related data,
as a response to including verifying answer relevancy, verifying answer relevancy is averaging cosine similarity between the question and the answer, and
as a response to including verifying groundness, verifying groundness is averaging cosine similarity between the answer and the related data.

7. The artificial intelligence service method of claim 6, wherein when verifying context relevancy, verifying answer relevancy, and verifying groundness are included in a predetermined threshold range, it is determined that a current response passes verification.

8. The artificial intelligence service method of claim 7, wherein verifying answer relevancy and verifying groundness are stricter than verifying context relevancy.

9. The artificial intelligence service method of claim 3, wherein the keyword search comprises BM25 Best Match 25.

10. The artificial intelligence service method of claim 1, wherein the second relevance search calculates cosine similarity between the vector-representation query and vector representations of each of the N related data chunks, and re-ranks the N related data chunks based on a magnitude of the cosine similarity.

11. The artificial intelligence service method of claim 1, wherein the second relevance search uses, in addition to cosine similarity, a relevance score calculated by a cross encoder or a language-model-based re-ranker.

12. The artificial intelligence service method of claim 1, wherein improving the first question into the second question comprises reconstructing the question by adding or deleting a core keyword, a scope, or a condition of the question, based on an item in which a verification result fails to satisfy the threshold range.

13. The artificial intelligence service method of claim 12, wherein the second question is rewritten to reduce ambiguity while maintaining a semantically same scope as the first question.

14. An artificial intelligence service apparatus, for obtaining a response to a user question based on Retrieval-Augmented Generation, comprising:
at least one memory storing data and at least one instruction for processing the data; and at least one processor executing the instruction,
wherein the at least one processor, in order to obtain a response to a user question, performs:
converting the user question into a vector-representation query;
from the at least one memory, performing a first relevance search based on a criterion having high first relevance to the vector-representation query and searching N related data chunks;
re-ranking the N related data chunks based on a criterion having high second relevance to the vector-representation query;
selecting, from among the N related data chunks, M related data chunks having high second relevance;
generating the response by using the M related data chunks and the vector-representation query;
verifying the response; and
when the response passes the verification, outputting the response as a final response, and when the response fails to pass the verification, suppressing transmission or display of the response and improving the question into another question and providing the improved question.

15. The artificial intelligence service apparatus of claim 14, wherein the first relevance search and the second relevance search evaluate relevance by different methods.

16. The artificial intelligence service apparatus of claim 15, wherein the first relevance search uses a hybrid search combining keyword search and semantic search, and the second relevance search uses cosine similarity.

17. The artificial intelligence service apparatus of claim 14, wherein M and N are natural numbers, and M is smaller than N.

18. The artificial intelligence service apparatus of claim 14, wherein the at least processor controls, when a verification result fails to satisfy the threshold range, not to output the response and to improve the question to perform re-search.

19. The artificial intelligence service apparatus of claim 14, wherein the apparatus is configured such that at least one of an embedding generation module, a response generation module, a verification module, and a query improvement module operates while being connected to an external model hub via an API.

20. The artificial intelligence service apparatus of claim 19, wherein the model hub stores or provides a plurality of models such that the embedding generation module, the reduction module, the response generation module, the verification module, and the query improvement module operate as different models.
